(19) United States
(12) Patent Application Publication
(10) Pub. No.: US 2015/0066520 A1
(43) Pub. Date: Mar. 5, 2015

(54) Standardized Pet Health Decision Support System and Method

(71) Applicant: Whiskers Worldwide, LLC, Skokie, IL (US)

(72) Inventors: Debra Leon, Long Grove, IL (US); Trevor Page, Long Grove, IL (US)

(73) Assignee: Whiskers Worldwide, LLC, Skokie, IL (US)

(21) Appl. No.: 14/011,538

(22) Filed: Aug. 27, 2013

(51) Int. Cl. G06F 19/00

(52) U.S. Cl. CPC G06F 19/3481; G06F 19/3443
USPC 705/2

(57) ABSTRACT

A method for standardizing pet health care decision support may include the steps of: displaying a portal to a user for input of a pet health care query; receiving the query; analyzing the query to determine which one of a plurality of decision trees to present to the user; presenting queries contained within the determined decision tree to the user; receiving responses for each query; storing the responses in the database; and analyzing the responses and presenting the user with a predetermined course of action. Each decision tree preferably is standardized for a plurality of users, i.e., each user that provides the same information at each node should be taken along the same branch and reach the same ultimate result. In addition to determining the next query to pose to a user, data provided by the user may be saved and used to generate a standardized, customized health record summary.

### BACKGROUND OF THE INVENTION

The invention relates generally to a decision support system and method, and more specifically to a pet health decision support system and method.

Traditionally, when a pet is sick or has a condition that a pet owner does not know how to treat, the pet owner's only option is to take the pet to a doctor of veterinary medicine (“veterinarian,” “DVM,” or “vet”) for advice and treatment. Taking the pet to a veterinarian is the right course of action if the pet is experiencing life threatening symptoms and the situation is an emergency, but it is not necessary in many situations to bring the pet to a veterinarian immediately, if at all.

At the same time, the pet owner likely does not have sufficient knowledge to fully appreciate the mildness or severity of the pet's condition, so the owner may not know whether the pet's malady is serious enough as to require immediate attention or whether it is something that can be monitored and managed without professional intervention. In these situations, the owner may elect to err on the side of caution and bring the pet to the vet, even when it turns out that a more passive approach may be sufficient. While the owner has the pet's best interests in mind, these frequent visits to a DVM in non-emergency situations can become expensive and inconvenient for the pet owner.

When a pet owner takes the pet to a DVM, it is important for the DVM to have access to health information including demographic information of the pet, records from previous visits, preexisting conditions, and other similar information in order to accurately assess the pet's condition. In some instances, this information is not available to the veterinarian at the time of the visit, for example, when it is an emergency visit or when the pet is a new patient. Transferring hardcopies of the relevant information may take time and in many instances, the hardcopies are not complete.

Perhaps more importantly, the DVM may benefit from having a record of the pet's current symptoms, although a pet owner may not remember all of those symptoms or may forget to tell the vet something in the limited time that usually encompasses a visit. In addition to potentially leading to inaccurate treatment, this may leave pet owners feeling as if they missed out on the opportunity to have their questions answered.

Conversely, while the DVM may be trained to perform a quick, thorough analysis in order to accurately and completely assess the pet's condition, the DVM inadvertently may forget to ask about or look for one or more symptoms, which may result in the pet receiving less than total care and which may subject the DVM to scrutiny later on.

What is needed is a system and method that addresses one or more of the issues presented above.

### SUMMARY OF THE INVENTION

In one aspect, a method for standardizing pet health care decision support may include the steps of: displaying a portal to a user for input of a pet health care query; receiving the pet health care query, by a computer having a processor, the computer operatively connected to a database; analyzing, by the processor, the query to determine which one of a plurality of decision trees to present to the user; presenting queries contained within the determined decision tree to the user; receiving responses for each query; storing the responses in the database; and analyzing the responses and presenting the user with a predetermined course of action. Each decision tree preferably is standardized for a plurality of users, i.e., each user that provides the same information at each node should be taken along the same branch and reach the same ultimate result. In addition, there may be commonality or overlap between multiple decision trees, in that at least two of the plurality of the decision trees may include a common sequence of branches.

The method also may include the steps of retrieving the responses from the database and building a health record summary from the responses. In addition, the building step may include the sub-steps of retrieving a health record summary template and populating fields in the template with user response data. The method further may include the steps of: prompting the user to enter demographic information about the pet, receiving and storing the demographic information in a database, retrieving the demographic information from the database, and including the demographic information in the health record summary.

In another aspect, a method for standardizing pet health care decision support, may include the steps of: storing a plurality of branching logic algorithms on a server accessible over the Internet by a plurality of user computers; storing a plurality of articles on pet health care issues in a database operatively coupled to the server; providing, by the server, a portal accessible by the plurality of user computers; obtaining, via the portal, a user request to access one of the branching logic algorithms; prompting the user for a data input for the requested algorithm; receiving the data input from the user and storing the data input in a database; determining a next prompt for the user based on the accessed branching logic algorithm; repeating the prompting and receiving steps until an exit point is reached, wherein the exit point corresponds to a recommendation for the user; and presenting the user with the recommendation corresponding to the exit point. Branching logic algorithms may be the same for two users that have the same initial query, which may help create a standardized data collection and recordation process.

The method also may include the steps of: accessing a health record summary template; retrieving at least some of the data input from the database; and populating the health record summary template with the retrieved data. Additionally or alternatively, the method may include prompting the user to provide demographic data relating to a pet; and receiving the demographic data and storing the demographic data in a database.

Various outcomes are possible as a result of the branching logic. For example, one outcome of the accessed branching logic algorithm may be to provide a user with one or more of the stored articles. At the other end of the spectrum, another outcome of the accessed branching algorithm may be instructing the user to seek immediate medical attention for the pet. The algorithms may be configured to reach this determination of potential emergency situations at or near an outset of the algorithm.

In either case, the portal may be accessible to the user in a number of different ways, including via a website to communicate over the Internet with the servers hosting the portal. The portal also may be accessed over the Internet and/or over mobile telecommunication lines through the use of a dedicated application installed on a mobile device. Still further, the user may be in communication with another person, e.g., a veterinarian or a chat representative. The other person may be in communication over the Internet with the portal and may serve as a proxy for the user

These and other features and advantages are evident from the following description of the present invention, with reference to the accompanying drawings.

### DESCRIPTION OF THE DRAWINGS

FIG. 1 is a schematic view illustrating local systems in communication with a remote web server and database in an embodiment of the system.

FIG. 2 is a flowchart showing one method of accessing the system and creating an account for an embodiment of the system.

FIG. 3 is a flowchart showing one way in which the user can interact with the system.

FIG. 4 is a flowchart showing another way in which the user can interact with the system.

FIG. 5 is a flowchart showing one example of a data aggregation methodology.

FIG. 6 is a flowchart showing another example of a step-by-step data aggregation methodology or decision tree; and

FIG. 7 is a screenshot of user's customer account settings with accessibility to a registered user's previously created pet health records or query summaries.

### DETAILED DESCRIPTION

A system and method for standardizing pet health care decision support is described herein. The system also may include data aggregation and retention and further may enable integration with third party resources for further data implementation.

While the system may be used to implement decision support in various areas, it may be particularly well suited to the realm of pet health care decision support. In that regard, the system may receive a plurality of user inputs relating to user observations or subjective assessments with the goal of recommending a next course of action from among a plurality of possible options.

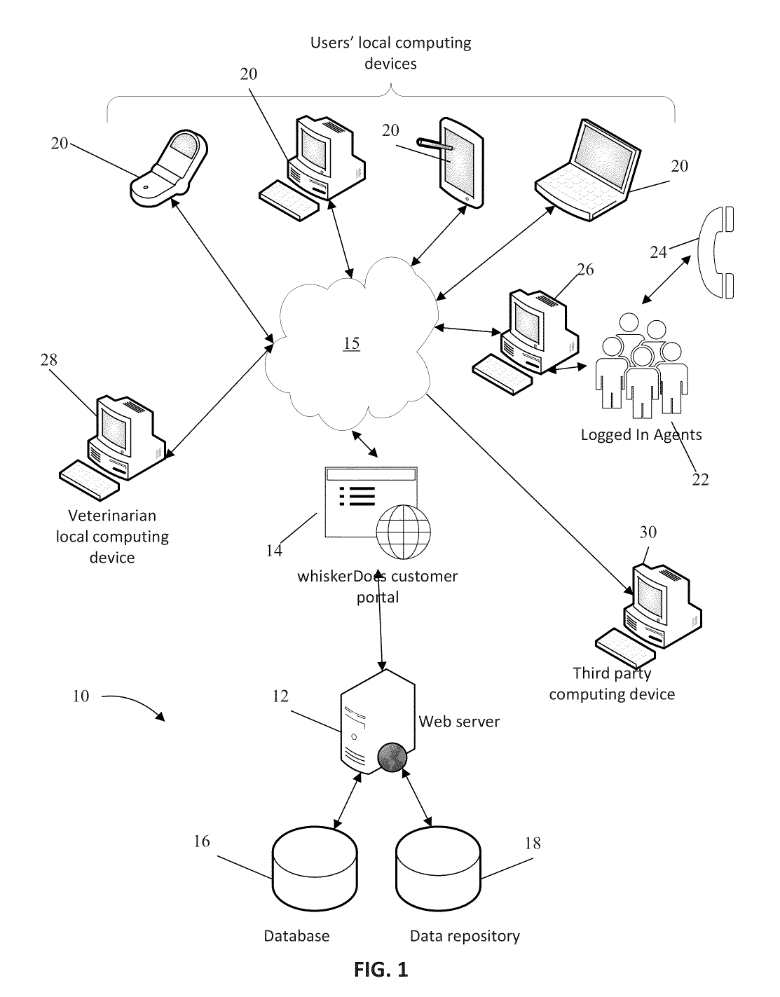

As seen in FIG. 1, the system 10 may include a server 12 configured to host a web-based interactive portal 14, e.g., in a cloud computing environment 15. The server may include or be operatively coupled to one or more databases 16 or other data repositories to store user-supplied data. A second database/data repository 18 or a second partition of the database/data repository may store system provided data, e.g., one or more knowledge bases, for serving to users. Knowledge base may include user profile data, decision trees, educational materials, and other data displayed to users from system 10.

In order to obtain the user-supplied data elements, server 12 may host or access customer relationship management (CRM) software, which may generate portal 14, providing means for obtaining end user data and/or presenting system provided data. In one embodiment, the CRM software and/or database may be provided by Oracle, such as the Oracle RightNow CX Cloud Service. Portal 14 may be served in various ways, including, e.g., as a series of webpages and/or as a mobile application.

A plurality of users of a first class may use multiple computing devices 20 to interact with the system by using the portal in order to obtain information in response to one or more queries and/or to provide the system with data points to implement a decision support methodology. Local computing devices 20 may include desktop or laptop computers, tablets, smart phones, or other devices with Internet, intranet, extranet, peer-to-peer, WAN, LAN, or other types of networks that are capable of communicating with the cloud computing system. Local computing devices 20 each preferably includes a processor coupled to an input interface and a display or output device. The input interface may be a keyboard, a touch screen, or device capable of receiving user inputs.

In another embodiment, a user may speak with an agent 22 in person or over the telephone 24. That agent may be connected to the system 10 via a computing device 26 in communication with the portal 14 and may be able to enter the user's data.

Returning to FIG. 1, a second class of users with access to the system 10 via computing devices 28 may include veterinarians or other knowledge providers who may interact with the end users to extract data elements from the users or otherwise assist in the decision support process, as discussed in greater detail below.

Also as discussed below, a third class of users using computing devices 30 may comprise third party analytic entities that may use at least some of the data provided by the end users for one or more additional purposes. For example, one set of third party users may comprise insurance companies that may access end user supplied data, e.g., to evaluate claims relating to pet health care or to verify the system's compliance with acceptable practices.

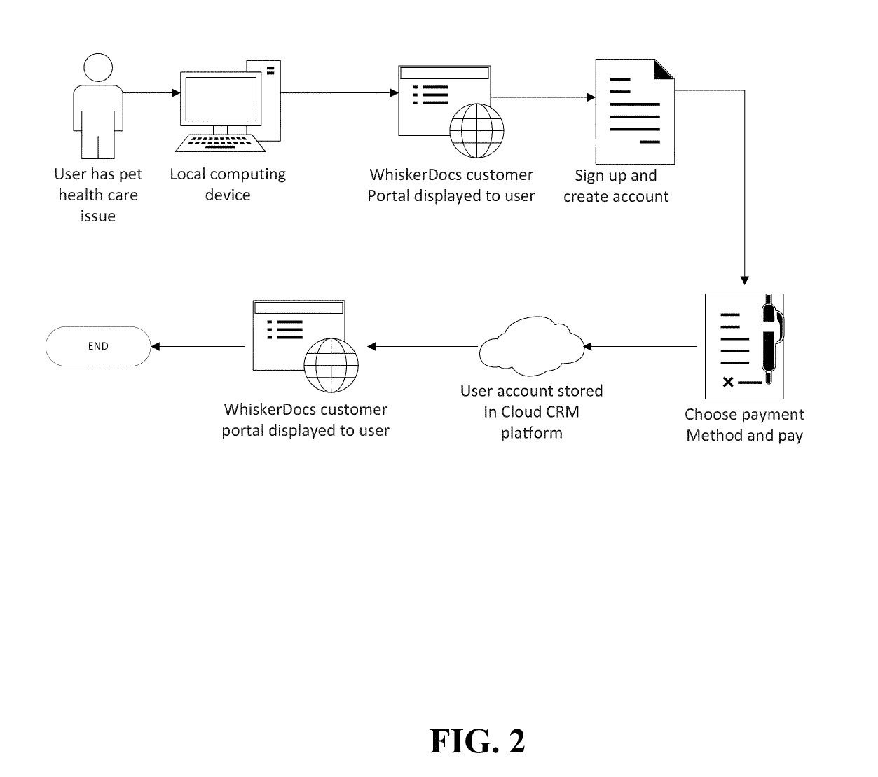

In one embodiment, as shown in FIG. 2, a user of the first class described above may access a web-based customer portal to create an account. User may access customer portal on a web browser of a local computing device by requesting the customer portal from a web server. Several components of the system may apply whether the user is logged in to his or her account or not, although additional components may be available to logged in users. For example, both logged out and logged in users may be able to progress through an information-gathering decision tree, as discussed below, but responses entered by a logged in user also may be added to a record generated for the user, which may be formatted and/or transmitted to the user's veterinary provider.

On subsequent “Create a Profile” pages, the system may present further queries and fillable fields to the user regarding additional pet demographic and health information, including but not limited to age, gender, species, breed, and pre-existing conditions, for each pet entered by the user. The system also may include an option to upload other documents related to a health record of a pet, including past records from a veterinarian. Any uploaded files may be stored in a database of the system, such as database 16, and may be accessible to the user upon logging in and accessing the account tab on the customer portal homepage.

Staying with FIG. 2, the user account or profile may be stored in the database associated with the cloud customer relationship management (CRM) platform, and the user may be returned to the customer portal homepage, thereby completing the registration process. Again, this information can be submitted at a different time, such as during part of the decision support process, although it may be beneficial to provide it at an outset so that it may be available readily across multiple query sessions at different times.

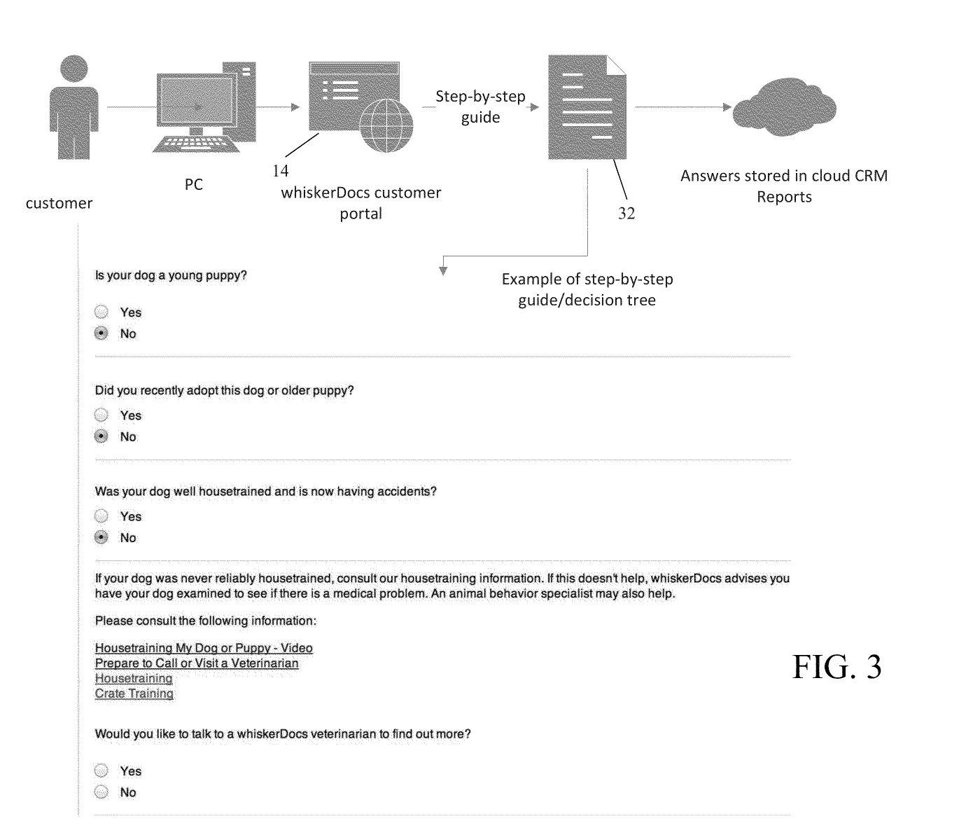

Turning now to FIG. 3, a user may access portal 14 for decision support relating to a pet health care issue. To begin, the user may input a pet health care query, which may be transmitted via the portal to the central server. The server may receive the pet health care query and may access a decision tree 32 in order to determine the progression of decision support data collection. System 10 may include a plurality of decision trees 32 or a plurality of branches expanding from proximate a parent node of a single tree.

The user can access step-by-step guides for a wide range of pet health topics including but not limited to a pet with diarrhea, housetraining problems, vomiting, weight loss, weight gain, litter box use, barking issues, disorientation, aggression, pet lethargy, coughing, constipation, limping, marking, and many other pet health topics. The memory device or database may be updated periodically with additional guides covering other pet health issues and/or with additional questions within a guide in order to elicit more or different information.

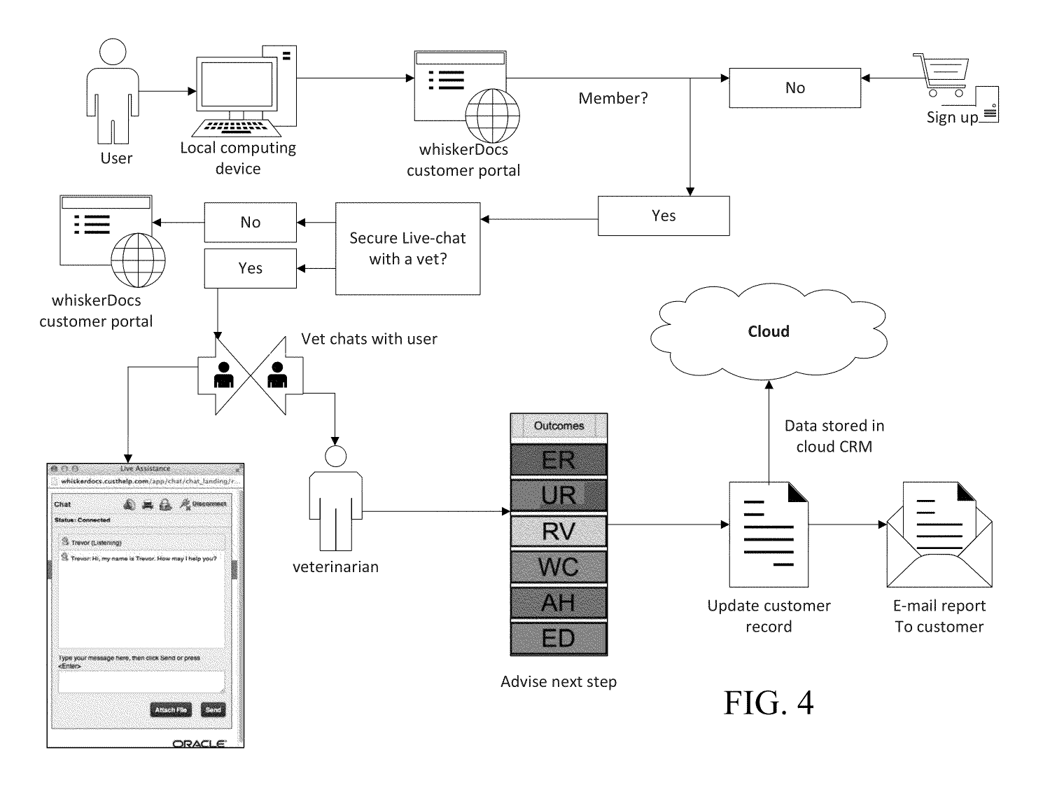

System may provide access to decision trees in one or more of a plurality of possible ways. For example, the user may be directed to one or more decision trees as the result of a query entered in a search bar. The system also may provide a listing of a plurality of possible decision trees, which may be categorized according to specific behavior or health indicators. The user also may be directed to one or more lists via interaction with a veterinarian or other system user. As seen in FIG. 4, the system may include the capability to connect the user with a veterinarian in a live chat environment, and the veterinarian may push the content (which may include a link to the query tree) to the user as part of that chat. Still further, the system may include a database of educational information on a multitude of topics, and links to the queries may be provided on the pages displaying that information in the event that the user desires a more personalized interaction rather than the generalized articles.

Decision trees for each subject may be categorized into a plurality of groups of questions. In one embodiment, this categorization may include three sets or types of questions. A first set of questions may be demographical, e.g., to identify the species of animal for which information is sought. Additional questions in the first set may be directed towards the type of animal, age, sex, breed, etc. These questions may not be dependent upon the specific information sought by the user but instead may be common to one or more subjects. As such, they may be represented as a parent set of branches from which the decision trees expand, or they may be redundant branches in multiple trees.

Upon analyzing the response to one or more demographical questions, the processor may present a user with one or more questions from a second set of questions. The second set of questions may include targeted, symptom based questions used to determine quickly if the situation is an emergency without having to traverse an entire decision tree. The questions may be directed towards fatal symptoms, such as bleeding or excessive vomiting. If a predetermined response or sequence of responses is received, the system may exit the decision tree process and instruct the user to seek immediate assistance and diagnosis.

If the processor determines the situation is not an emergency, it may present questions from a third set of questions to the user. The third set of questions may be general questions related to non-emergency symptoms, behaviors, and conditions of a pet. The processor may present questions to the user and analyze each response to determine if it has enough information to recommend a course of action. In one embodiment, once the processor determines it has enough information, no further questions are presented to the user and the processor displays a recommended course of action to the user. In another embodiment, the system may proceed through a tree until an exit point is reached, which may be at the bottom of the tree or which may be at some higher point, as discussed above.

As part of the process of accessing and progressing through a decision tree, the system may analyze the user's query/input to determine which decision tree or which branch within a tree to access. This analyzing step may include searching the user's query for one or more keywords to determine a location, severity, duration, or other symptom of a condition for which information is desired. This analysis may be particularly suited to an initial query, where descriptive information such as type of animal and chief complaint may be retrieved from the text of a user's query.

Alternatively, the system may provide prompts to the user in order to guide the user toward the correct decision tree or branch. For example, the system may present the user with a yes/no question, where an affirmative answer may indicate to the system to execute one tree or set of branches and a negative answer may indicate to the system to display a second, different tree or set of branches. Or the system may prompt the user to select each of a category of responses that may be applicable, e.g., prompting the user to select each symptom that the animal is displaying. Data may be received according to one or more means, e.g., radio buttons, drop down menus, text entry fields, etc.

The system then may analyze the received data, e.g., the number of symptoms being displayed, the presence or absence of one or more symptoms preconfigured as being more severe than others, and/or whether a certain combination of symptoms is present that may trigger a predetermined response.

Similar to the analysis described above, these prompts may seek to categorize the user's query according to location, severity, duration, or other symptom.

As the user continues to answer questions by inputting responses, thereby traversing the decision tree, the system receives, stores, and continuously analyzes the user's responses. If the system determines it does not have enough information to make a recommendation, it presents additional questions to the user and analyzes the user inputted responses along with all previous responses, until it has enough information to recommend a course of action. When the system determines it has enough information, it ceases questioning and displays a recommended course of action for the user to take with respect to the pet health issue. When the system recommends that the user take the pet to a veterinarian, the system offers the option to connect the user to a veterinarian.

System 10 may recommend one of a plurality of possible outcomes after analyzing user inputted responses to questions, and outcomes may be classified in terms of severity. As mentioned above, one possible outcome may be the indication to the user of an emergency situation, which may cause the system to exit the data gathering portion and which may cause the system to present the user with instructions to seek immediate assistance.

Exemplary outcomes, listed in decreasing order of severity, may include: ER—emergency room (i.e., seek immediate medical attention), UR—urgent situation (i.e., seek medical attention ASAP, as responses could indicate a serious condition), RV—recommended veterinarian visit (i.e., seek medical attention soon, although more at the user's convenience), WC—watchful care (i.e., observation, although it may require escalation if the condition does not improve or if certain criteria are not met in the near term), AH—at home treatment (i.e., no vet visit required), and ED—education (i.e., can be coupled with each of the above outcomes to provide more information or may be associated with behavioral issues or other issues that likely would not require veterinary assistance).

Queries also may be determined based on input from a veterinarian or other health care practitioner, drawing upon their experience and knowledge to determine both the content and ordering of those queries. In one aspect, data collection and decision support processing may be arranged so as to determine the likely presence or absence of outcomes progressively in descending order of severity. In another aspect, it may be determined that only situations requiring immediate attention, e.g., ER and/or UR situations or ER situations only, may require preliminary determination. After that, the DVM may decide, e.g., that questions should correspond to a head-to-toe analysis of the animal or that they should be grouped as relating to a first possible condition, followed by a second series of questions geared toward a second possible condition, etc.

Data queries may be presented serially to the user. As the system receives a response to each question, the processor may analyze the responses to determine the next question or series of questions, and it may provide a recommend course of action to the user on how to proceed. For example, the system may include a plurality of branching logic algorithms where each answer received from the user prompts a predetermined response. While multiple responses may be possible for a question, those questions preferably are arranged in a one-to-one relationship with their immediately preceding questions.

The system may receive and store each response in a database and may analyze the response to determine if there is enough information to recommend a course of action. The analysis process may take into account the most recent response and any previous user inputted responses, although consideration of previous responses may be taken into account in the determination of the most recent query. If the processor determines there is not enough information to recommend a course of action, an additional question may be presented to the user, and the receiving, storing, and analysis steps may be repeated until the system determines that there is enough information to recommend a course of action.

Decision trees may simulate a real-time visit with a veterinarian and may be based on questions a veterinarian may ask to determine a course of action to handle a pet health care issue. Decision trees may provide a recommended course of action on how a user should proceed in handling a pet health care condition or behavioral issue. User may access decision trees by searching for an answer, selecting a tree from a list under behavior or health categories on the homepage, or by a veterinarian presenting a link in an e-mail, chat, or other interaction. In another embodiment, a veterinarian may also present questions and may traverse a decision tree with user.

In any case, each user with the same question or having an animal with the same symptoms as another user may traverse the same decision tree and in the same order as the other similarly situated user. Moreover, the system may be configured to give the same response to each user that provides the same input. As such, a standardized decision support service may be created, which may provide clinical consistency and continuity of care or information presentation.

In addition, each client interaction, including entry provided by the user may be recorded and stored in a database, so that the system may create an audit history of the user's interaction.

In an embodiment, user inputted responses to the decision tree questions may be stored in the database of the remote web server, and they may be accessible by a veterinarian in a subsequent interaction. The responses may be used by the veterinarian as background information, which may prevent the veterinarian from repeating questions the user already has answered. The system also may store the user input responses in the user's pet's profile and may enable those responses to be accessed at a future date, e.g., if the user wants to show the responses to a veterinarian in a subsequent appointment.

Data points also may be used to generate a report of the user's interaction, which then may be used to create or to integrate into a patient's health record. In one aspect, the health record may be electronic, whereby the report may be formatted in an electronic format capable of being read by or integrated into a health record software package. One such format may be XML, although other machine readable and/or parsable file formats are acceptable. Alternatively, many DVM's and their offices may retain paper records, such that the output file may be of a format that is readily printable, such as .doc, .rtf, .pdf, .txt, .jpg, .tif, etc.

Just as the system may provide clinical consistency and continuity in the data accumulation process, this also may lead to consistency in data aggregation and reporting, which may help ensure that each user receives the same quality of analysis. It also may ensure reporting in a consistent format, which may assist ultimate care providers in analyzing the user-provided data, which in turn may increase the care provider's speed, thoroughness, and accuracy of review.

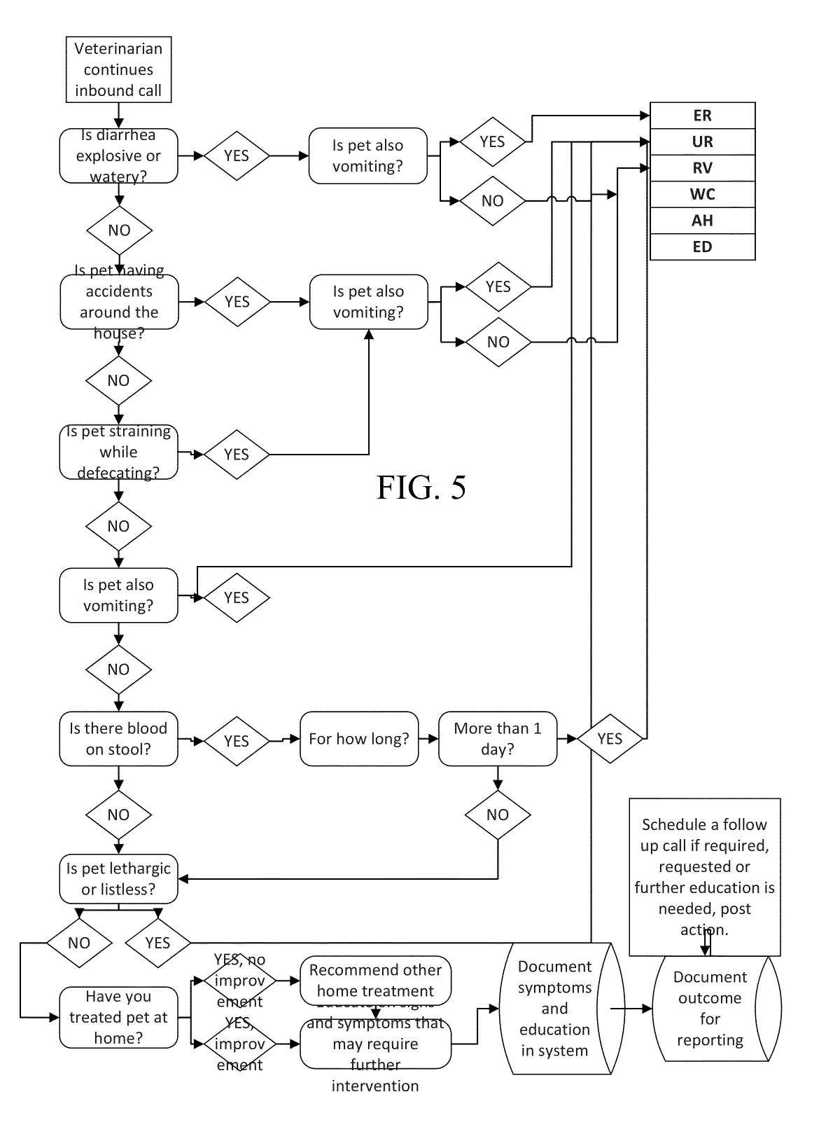

An example of the questioning process is shown in FIG. 5 for an embodiment of a decision tree. This subroutine may be accessed in several ways, e.g., the user may search for “pet with diarrhea” in a portal search box. Alternatively, portal 14 may include a section devoted to decision support trees 32 (which may be organized and/or displayed according to chief complaint), and the user may search for and select the desired tree. In any event, if a user selects a “pet with diarrhea” decision tree, the first question the system presents may be demographical, such as “Is your pet a bird or exotic animal (not a dog or cat)?” If the system receives “No,” the second question may be a question directed to determine if the situation is an emergency, such as “is diarrhea explosive or watery?” If the user inputs “yes” to the second question the system might present “Is the pet also vomiting?” as a follow-up question. If the user inputs “yes” again, the analysis component of the processor now has enough information to determine that this may be an emergency situation (ER), and outputs “WhiskerDocs recommends you take your pet to the emergency room immediately.”

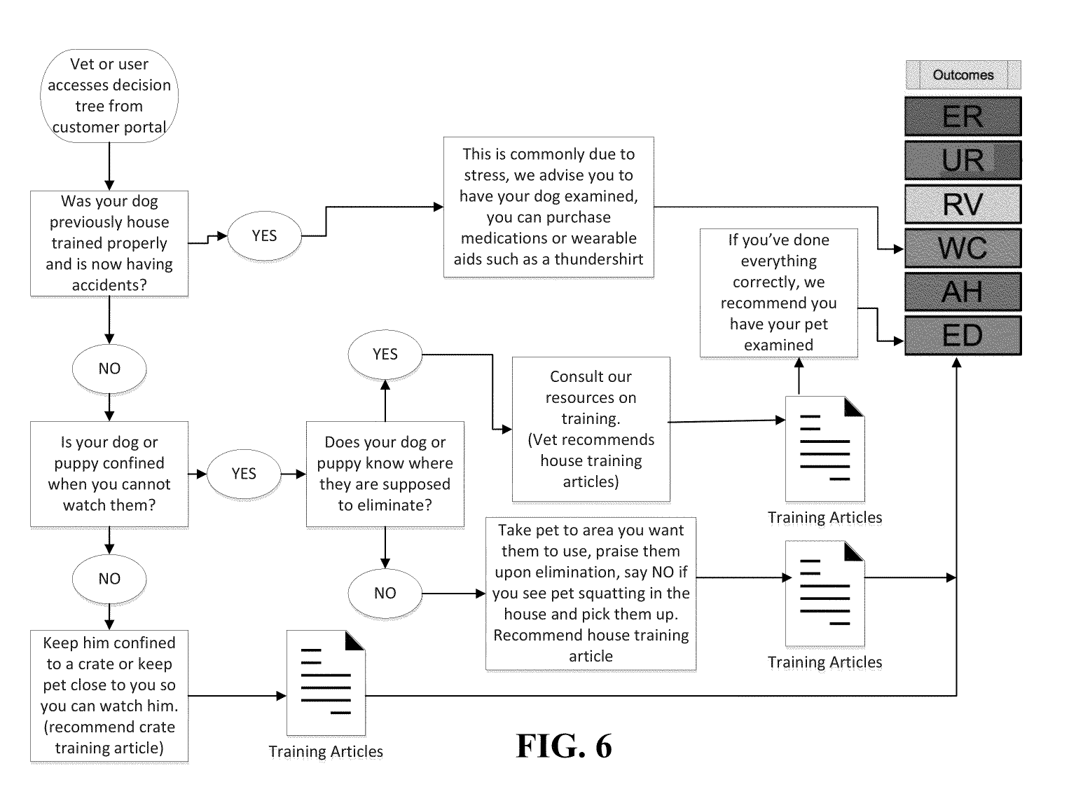

Referring now to FIG. 6, a flowchart illustrating another example of a step-by-step guide or decision tree—this one for housetraining a pet—is shown. The decision tree is accessed either by a user from the web-based customer portal or by a veterinarian if a user calls into the system. The system presents each question to the user or the veterinarian and receives a response to each question. Based on the response, the processor traverses the decision tree and presents another question or displays a recommended outcome. For the decision tree shown in FIG. 5, the system can either recommend that the user provide watchful care for the pet, WC, or offer to educate the user by providing training articles. This example also illustrates that each branch in each decision tree preferably terminates at least one of the desired predetermined outcomes, i.e., there preferably are no “dead” branches for which the system is unable to provide the user with some kind of affirmative outcome.

Each of the user's responses may be stored in a database, such as database 16, and a patient visit summary may be generated that includes the information provided by the user by accessing the database to retrieve that information. If the user presents sufficient information to identify the specific animal being discussed, the report can be tailored to that animal, which may prevent the record from being lost or accidentally being inserted in a different animal's file.

In one embodiment, the report may be based on a predetermined template, which may add to the standardization achieved by the system. For example, the pet's demographic information may be indicated at the top of the report, followed by the current chief complaint with an explanation of the owner's observations below, followed by any other problems previously indicated to the system by the user. As such, a standardized report may be created, enabling a practitioner to quickly and efficiently review the report and glean important information, thereby contributing to a more complete, more accurate evaluation.

The system also may connect the user to a veterinarian and create a pet health record entry or summary from any information input into the system or any interaction between the veterinarian and the user relating to a pet health care issue.

The “ED-Education” outcome may include providing the user with one or more electronic pieces of information about the topic queried by the user. These pieces of information may include journal articles, summaries, pictures, etc., and they may be stored in database 16 for serving to the user. Information may be provided by pushing it to the user when a predetermined outcome is reached or, alternatively, links to the information may be presented to the user so that the user can retrieve whatever content, if any, he or she desires.

While “Education” may be one of the desired system outcomes, it also may be an outcome that is available at more than just a final stage of the analysis. For example, educational information or links to such information may be presented at multiple branches, although the number of items or the content of the information may be refined as the system receives more responses and is able to exclude likely less relevant information.

When a veterinary visit is recommended, the system may offer to connect the user with a veterinarian. The user may connect with a veterinarian by telephone, web-based chat, e-mail, or mobile messaging.

Upon connecting with a veterinarian, the system may store interactions between the veterinarian and the user as part of a report or pet health record entry associated with the user's account. Over time, the health record summary may be updated by building off earlier queries. These earlier queries may be used to generate a list of potential pre-existing conditions, although it may be preferable solely to list them in terms of the earlier observed symptoms, since it is likely that no formal diagnosis occurred at those earlier times.

The health record summary generated by the interaction may be portable in that it may be user-accessible from any local computing device that can access the customer portal to log into the user's account. As mentioned above, the health record may be shown to a veterinarian at an office visit to provide the veterinarian with information that may be useful in making a diagnosis or recommending a course of action.

In an embodiment, the health record may include pet demographic information entered by the user during a create an account process or anytime after an account is created, interactions completed on the system between a veterinarian and a user regarding a pet, data received and stored by the system while user is logged in, and previous veterinary records sent or inputted into the system by the user, a veterinarian, or an agent of the system. The health record may be updated with new pet health information and records after each interaction on the system. Entries from the health record also may be e-mailed to an outside veterinarian or a third party with consent from the user.

In one embodiment, upon connecting with or contacting a veterinarian, a pet's health record may be transferred from a database, e.g., database 16 or 18 of system 10, to a local computing device 28 that the veterinarian is using. The veterinarian may then consider the information in the pet's profile and health record as background information and use the information to determine a recommended course of action. Should the veterinarian need more information from the user, the veterinarian may access and traverse a decision tree asking respective questions and inputting responses from the user until the system recommends an outcome or until the veterinarian feels that he or she has sufficient information to present a recommended course of action to the user, which may include visiting a veterinarian in person to obtain a formal diagnosis.

As the veterinarian receives new or additional information from the user regarding the pet issue or presents information to the user (e.g., steps to treat a pet at home for a condition that does not require a veterinarian office visit), the veterinarian may update the corresponding pet health record stored in a database of the system. Upon the closing of the interaction with the user, the system may create an encounter report and may present the veterinarian with an option to schedule a follow-up call to check back with the user regarding the pet's condition.

In certain situations, such as emergency situations, the veterinarian may have the discretion to recommend a course of action immediately without accessing and traversing the decision tree. The veterinarian may then document the advice and recommendation in the CRM system and may enter the corresponding disposition or recommended course of action.

In another embodiment, a user can access a customer portal and chat with a veterinarian using a mobile computing device, such as a smart phone. The mobile chat application may have the same capabilities as the web-based chat. The mobile chat application may allow a user to take a picture, video, or sound recording with a mobile device and transmit it directly to the veterinarian, and each piece of this additional data may be stored in database 16 and may be added to the animal's health record summary.

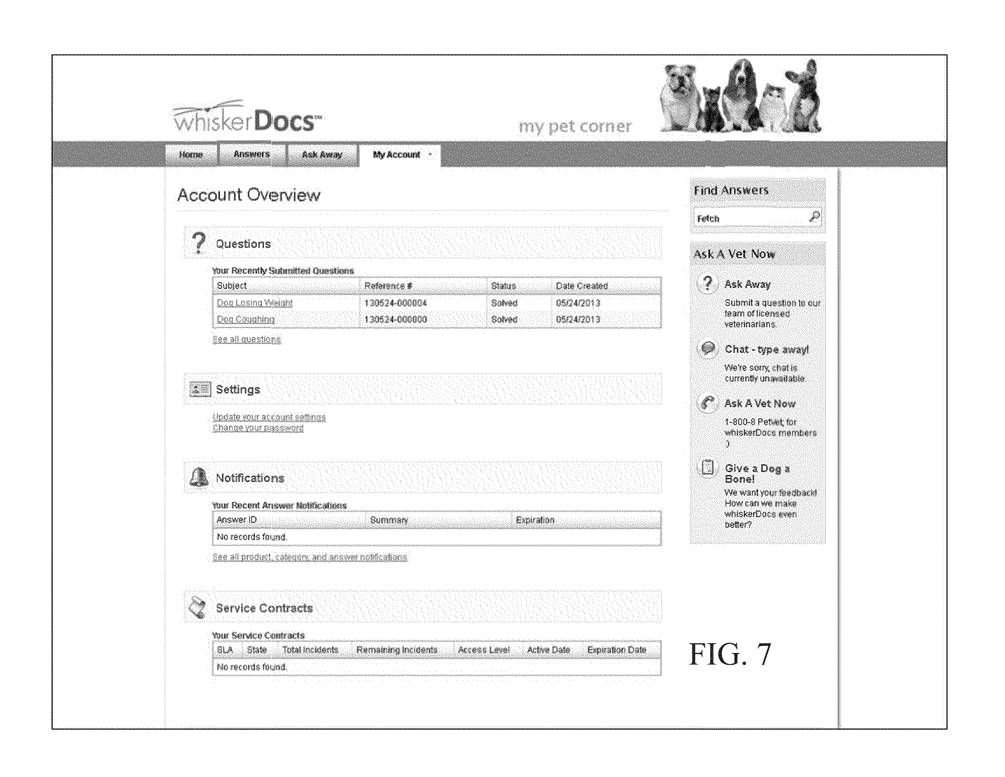

Turning now to FIG. 7, a screenshot of a customer account summary that is accessible by a registered user is shown. As can be seen from this figure, in the system 10, a registered user may be able to access previously-created reports or pet health record entries by logging into the account, selecting the “My Account” tab from the customer portal homepage, and then selecting the report or health record entry by selecting an identifying link pertaining to that report/entry.

The health record may be accessible from any local computing device having access to the internet. All of the questions the user asked a veterinarian using the system regarding a pet health issue are shown under “Your Recently Submitted Questions” heading. The status of the questions, i.e., whether they are solved or unsolved is also indicated by the “Status” heading. The “Notifications” heading displays any answers sent to the user to recently asked questions. The user can also update account settings, change the account password, and view current and past service contracts from this page.

By presenting every user with the same question or series of questions, the system creates a standardized method for data collection and analysis. In addition, because successive questions presented to the user depend upon the answers provided by the user to previous questions, the data collection and analysis process is tailored to each user's specific condition.

Moreover, by recording each user's response to each data query, the system can provide accurate, complete data collection and standardized data reporting. This may benefit several classes of individuals. For example, the users seeking information may benefit by learning what course of action to take regarding their pets' conditions, veterinarians may benefit by being presented with a standardized record of the users' observations, insurance providers may benefit by knowing that a complete and standardized methodology is being followed, and the system operators may benefit by being able to generate and offer a repeatable analytical process and being able to keep full, complete, consistent records.

The system may include additional functionality that may result from recording users' data submissions. For example, the system may analyze queries from multiple users to determine which topics are being searched most often. Knowledge bases with the most queries may receive additional attention to ensure that they are up-to-date or as complete as possible.

Similarly, a large number of queries for a certain symptom or disease may indicate the presence of an outbreak. As such, the system may cross-reference the queries with the user's location in order to determine whether there is any geographic correlation. Location information may be provided by the user, e.g., when establishing an account, or it may be determined by the system, e.g., by using the geographic identifier associated with the user's IP address.

Similar analytic methods can be implemented from other user-provided information. For example, the user may be prompted to provide information pertaining to a pet's food source. Because food recalls typically are not geographically focused, the system may determine whether there is a correlation between a certain type or types of food and user requests for information regarding certain maladies, and this information ultimately may be used to support a request for a recall.

In this way, system 10 also may be useful for pet health risk assessment.

While the foregoing written description enables one of ordinary skill to make and use the same, those of ordinary skill also will understand and appreciate the existence of variations, combinations, and equivalents of the specific exemplary embodiments and methods disclosed herein within the scope and spirit of the claims.

What is claimed is:

1. A method for standardizing pet health care decision support, comprising:
displaying a portal to a user for input of a pet health care query;
receiving the pet health care query, by a computer having a processor, the computer operatively connected to a database;
analyzing, by the processor, the query to determine which one of a plurality of decision trees to present to the user;
presenting queries contained within the determined decision tree to the user;
receiving responses for each query;
storing the responses in the database; and
analyzing the responses and presenting the user with a predetermined course of action.

2. The method of claim 1, wherein each decision tree is standardized for a plurality of users.

3. The method of claim 1, further comprising:
retrieving the responses from the database; and
building a health record summary from the responses.

4. The method of claim 3, wherein the building step comprises:
retrieving a health record summary template; and
populating fields in the template with user response data.

5. The method of claim 3, further comprising:
prompting the user to enter demographic information about the pet;
receiving and storing the demographic information in a database;
retrieving the demographic information from the database; and
including the demographic information in the health record summary.

6. The method of claim 1, wherein at least two of the plurality of the decision trees include a common sequence of branches.

7. The method of claim 1, wherein the portal is accessible over the Internet using an Internet browser.

8. The method of claim 1, wherein the portal is accessible from a mobile application other than an Internet browser.

9. The method of claim 1, wherein the database includes a plurality of articles on a plurality of pet health care issues; and wherein the plurality of articles are servable to a user in response to the step of analyzing the user's responses.

10. A method for standardizing pet health care decision support, comprising:
storing a plurality of branching logic algorithms on a server accessible over the Internet by a plurality of user computers;
storing a plurality of articles on pet health care issues in a database operatively coupled to the server;
providing, by the server, a portal accessible by the plurality of user computers;
obtaining, via the portal, a user request to access one of the branching logic algorithms;
prompting the user for a data input for the requested algorithm;
receiving the data input from the user and storing the data input in a database;
determining a next prompt for the user based on the accessed branching logic algorithm;
repeating the prompting and receiving steps until an exit point is reached, wherein the exit point corresponds to a recommendation for the user; and
presenting the user with the recommendation corresponding to the exit point.

11. The method of claim 10, wherein a branching logic algorithm is the same for two users that have the same initial query.

12. The method of claim 10, further comprising:
accessing a health record summary template;
retrieving at least some of the data input from the database; and
populating the health record summary template with the retrieved data.

13. The method of claim 10, further comprising:
prompting the user to provide demographic data relating to a pet;
receiving the demographic data and storing the demographic data in a database.

14. The method of claim 10, wherein one outcome of the accessed branching logic algorithm comprises providing a user with one or more of the stored articles.

15. The method of claim 10, wherein one outcome of the accessed branching algorithm comprises instructing the user to seek immediate medical attention for the pet.

16. The method of claim 10, wherein at least one of the branching algorithms is configured at or near an outset to determine potential emergency situations.

17. The method of claim 10, wherein the portal is accessible over the Internet using an Internet browser.

18. The method of claim 10, wherein the portal is accessible from a mobile application other than an Internet browser.
